(19) United States
(12) Patent Application Publication
(10) Pub. No.: US 2019/0374961 A1
(43) Pub. Date: Dec. 12, 2019

(54) Spinner Base Mosquito Misting Device

(71) Applicant: Gary Stephen Moore, (US)

(72) Inventor: Gary Stephen Moore, (US)

(21) Appl. No.: 16/389,007

(22) Filed: Apr. 19, 2019

Related U.S. Application Data
(60) Provisional application No. 62/659,978, filed on Apr. 19, 2018.

(51) Int. Cl. B05B 3/10; B05B 3/12

(52) U.S. Cl. CPC B05B 3/1014; B05B 3/12; A01M 1/2044; B05B 3/1035; B05B 3/1021

(57) ABSTRACT

Exemplary embodiments of a mister of the current invention comprise a reservoir, a spacer, and a dispenser assembly. A spacer fixedly joins the reservoir to the dispenser assembly a set distance. A liquid stored within the reservoir is configured to exit the reservoir at the valve through the spacer and impinge the dispenser assembly. The dispenser assembly includes a dispenser and a motor, the motor providing a rotational force for application to the dispenser. The dispenser presents an axis generally transverse to the liquid stream flow from the reservoir. Upon liquid stream flow impinging the rotating dispenser, the centrifugal force causes the liquid stream flow to spread radially from the dispenser to the air and/or surface in the target area, where it is dispersed outwardly over a target area, atomized or as droplets.

### BACKGROUND

### Field of the Invention

The present invention relates to a system for dispensing liquids, more specifically to a mister.

### Description of the Related Art

It is often desirable to disperse liquid around an area. For example, it may be desirable to disperse a liquid mist for insect control or humidification.

### SUMMARY

The device described in this application is designed to disperse a liquid mosquito repellant suitable for protecting a small area such as a patio. Our device is conceptually based on the well-known spinning disc aerosol generator. When a liquid stream is fed onto the surface of a disc which is rotating a very high speed, the liquid will flow toward the edge of the disc because of high centrifugal forces. If the liquid reaches the edge of the disc, it will build up until small droplets break free of the disc. The predicted diameter is given by d=K/RPM*D^{1/2}) where ‘d’ is the droplet diameter, ‘K’ is determined by the properties of the liquid, ‘RPM’ is the rotational speed of the disc, and ‘D’ is the diameter of the disc. The equation cited is descriptive of an ideal case when the fluid separates from the rotating disc at its edge. For water based liquids, it is common for the liquid flow to depart the spinning disc before reaching the edge.

### BRIEF DESCRIPTION OF THE DRAWINGS

FIG. 1 shows an aspect of an embodiment of the invention;

FIG. 2 shows an aspect of an embodiment of the invention; and

FIG. 3 shows an aspect of an embodiment of the invention.

### DETAILED DESCRIPTION

The device described in this application is designed to disperse a liquid mosquito repellant suitable for protecting a small area such as a patio. Our device is conceptually based on the well-known spinning disc aerosol generator. When a liquid stream is fed onto the surface of a disc which is rotating a very high speed, the liquid will flow toward the edge of the disc because of high centrifugal forces. If the liquid reaches the edge of the disc, it will build up until small droplets break free of the disc. The predicted diameter is given by d=K/RPM*D^{1/2}) where ‘d’ is the droplet diameter, ‘K’ is determined by the properties of the liquid, ‘RPM’ is the rotational speed of the disc, and ‘D’ is the diameter of the disc. The equation cited is descriptive of an ideal case when the fluid separates from the rotating disc at its edge. For water based liquids, it is common for the liquid flow to depart the spinning disc before reaching the edge.

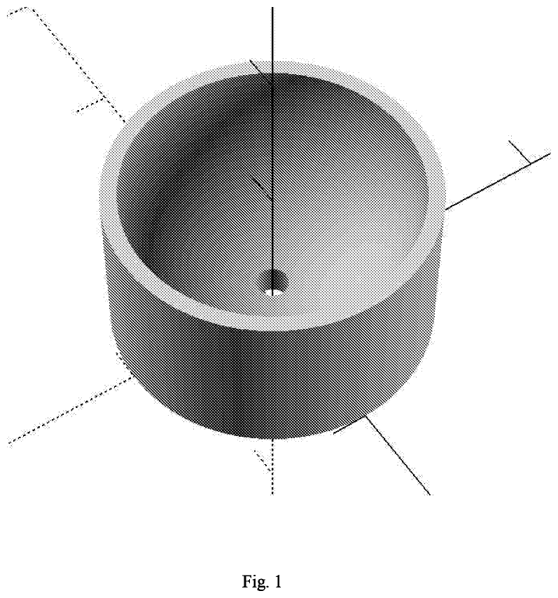

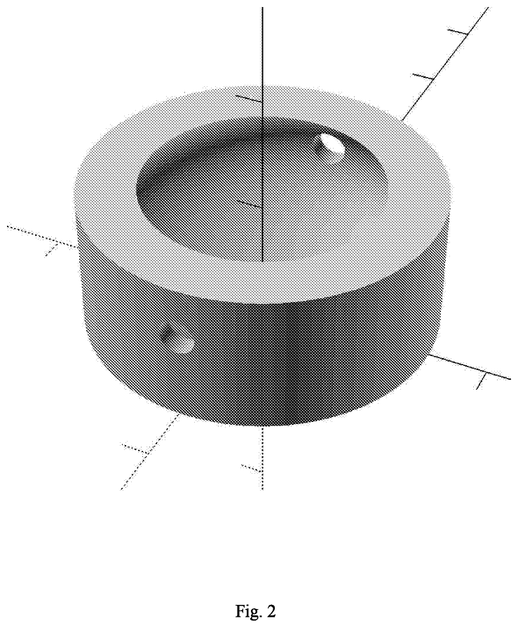

One aspect of our design is to replace the disc with a bowl shaped spinner into which the liquid is delivered. Under that circumstance, the liquid can't leave the spinner until it reaches the outer lip of the spinner thus guaranteeing that the liquid has reached full speed when it spills over the edge of the rotating cup. See FIG. 1 and photos included.

Typically, this design will generate particles small particles with high velocity. However, small particles will stop very quickly due to air resistance and only an area of a few feet distance will be coated with the liquid mosquito repellant. To address this issue the spinner design can be modified so that all the liquid flow must leave the spinner from two small holes. The practical result is to create larger particles with high velocity. See the second version of the spinner below.

While the dispersion of the liquid feed is improved by forcing the entire fluid flow through two small holes a significant fraction of the fluid flow adheres the surface of the rotating cylinder. This design does create a significant fraction of particles in the 100 uM range which are ejected at high velocities. However, they still fall short of the desired performance. A third design is shown below with has superior performance. In this design, the holes are placed at the apex of an angled surface which discourages liquid from adhering to surface of the spinner. See the example below.

By placing the ejection holes at the apex of the angular edge, the liquid can't easily adhere to the outside of the spinner. This design disperses large droplets at high velocity providing a means to cover a sufficient area for the application.

Misting system that moves large volumes of air, or requires high liquid pressure to generate the mist particles is inherently inefficient from an energy perspective. Such devices are not practical for battery operation. An advantage of a spinner-based dispersion scheme is that it is inherently energy efficient and it is therefore practical consider operating the generator from batteries.

What is claimed is:

1. A mister comprising:
a reservoir, a spacer, and a dispenser assembly;
a spacer fixedly joins the reservoir to the dispenser assembly a set distance;
a liquid stored within the reservoir is configured to exit the reservoir at the valve through the spacer and impinge the dispenser assembly;
the dispenser assembly includes a dispenser and a motor, the motor providing a rotational force for application to the dispenser;
the dispenser presents an axis generally transverse to the liquid stream flow from the reservoir;
whereby liquid stream flow impinging the rotating dispenser, the centrifugal force causes the liquid stream flow to spread radially from the dispenser in the target area, where it is dispersed outwardly over a target area.
